(19) United States
(12) Patent Application Publication
(10) Pub. No.: US 2025/0106352 A1
(43) Pub. Date: Mar. 27, 2025

(54) IMAGING CONTROL APPARATUS, IMAGE PICKUP APPARATUS, AND IMAGING CONTROL METHOD

(71) Applicant: CANON KABUSHIKI KAISHA, Tokyo (JP)

(72) Inventor: Yasushi OHWA, Tokyo (JP)

(21) Appl. No.: 18/823,805

(22) Filed: Sep. 4, 2024

(30) Foreign Application Priority Data
Sep. 22, 2023 (JP) 2023-156605

(51) Int. Cl. H04N 5/91; H04N 23/62; H04N 23/80

(52) U.S. Cl. CPC H04N 5/91; H04N 23/80; H04N 23/62

(57) ABSTRACT

An imaging control apparatus includes a processor configured to generate first image data for provisional recording in a nonvolatile memory from an output of an image sensor configured to perform imaging, control first processing from the imaging to the provisional recording, generate second image data for final recording by performing second processing for the first image data read out of the nonvolatile memory, and control the first processing so that an average writing rate of the first image data in the provisional recording can be equal to or higher than a speed based on an imaging rate of the image sensor.

### BACKGROUND

### Technical Field

The present disclosure relates to control of an image pickup apparatus configured to perform still image continuous shooting and moving image capturing.

### Description of Related Art

In a case where still images are continuously shot and recorded in a recording medium, the continuous shooting speed and the number of continuous shots may be restricted due to insufficient image processing speed, insufficient compression processing speed, and insufficient capacity of an intermediate buffer. If the circuit performance is enhanced (scaled up) to increase the processing speed and the capacity of the intermediate buffer, power consumption and cost increase. The resolution and frame rate of moving image capturing may also be restricted due to insufficient processing speed, and continuous imaging duration may be restricted due to insufficient capacity of the intermediate buffer.

Japanese Patent Laid-Open No. 2016-63252 discloses an image pickup apparatus configured to record a raw image and a scaled-down image of the raw image in a compressed manner in a storage medium, read the recorded raw image and perform development processing in the background, and perform development processing and playback display of the scaled-down raw image in playback display before the development processing of the raw image ends. This image pickup apparatus can mitigate the maximum development processing speed during continuous shooting.

Japanese Patent Laid-Open No. 2016-63252 does not disclose conditions and the like on imaging rates (continuous shooting speed and frame rate) and the writing rate and writing compression ratio to an intermediate buffer, and the number of continuous shots and continuous imaging duration may not improve.

### SUMMARY

An imaging control apparatus according to one aspect of the disclosure includes a processor configured to generate first image data for provisional recording in a nonvolatile memory from an output of an image sensor configured to perform imaging, control first processing from the imaging to the provisional recording, generate second image data for final recording by performing second processing for the first image data read out of the nonvolatile memory, and control the first processing so that an average writing rate of the first image data in the provisional recording can be equal to or higher than a speed based on an imaging rate of the image sensor or control an imaging rate of the image sensor based on an average writing rate of the first image data in the provisional recording. An image pickup apparatus having the above imaging control apparatus also constitutes another aspect of the disclosure. An imaging control method corresponding to the above imaging control apparatus also constitutes another aspect of the disclosure.

Further features of the disclosure will become apparent from the following description of embodiments with reference to the attached drawings.

### BRIEF DESCRIPTION OF THE DRAWINGS

FIG. 1 is a block diagram illustrating the configuration of an image pickup apparatus according to an embodiment.

FIGS. 2A and 2B illustrate a provisional recording area, a final (or definitive) recording area, and a nonvolatile storage medium in the embodiment.

FIG. 3 is a flowchart illustrating processing in which a user designates the provisional recording area in the embodiment.

FIG. 4 illustrates demosaic processing in the embodiment.

FIGS. 5A, 5B, and 5C illustrate the configuration of a provisional recording file in the embodiment.

FIG. 6 illustrates a provisional recording image file in the embodiment.

FIG. 7 illustrates data compression utilizing a correlation between images in the embodiment.

FIGS. 8A and 8B are flowcharts illustrating imaging processing in the embodiment.

FIG. 9 illustrates processing of setting the provisional recording area and the final recording area in the embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

An embodiment of the present disclosure will be described below with reference to the accompanying drawings.

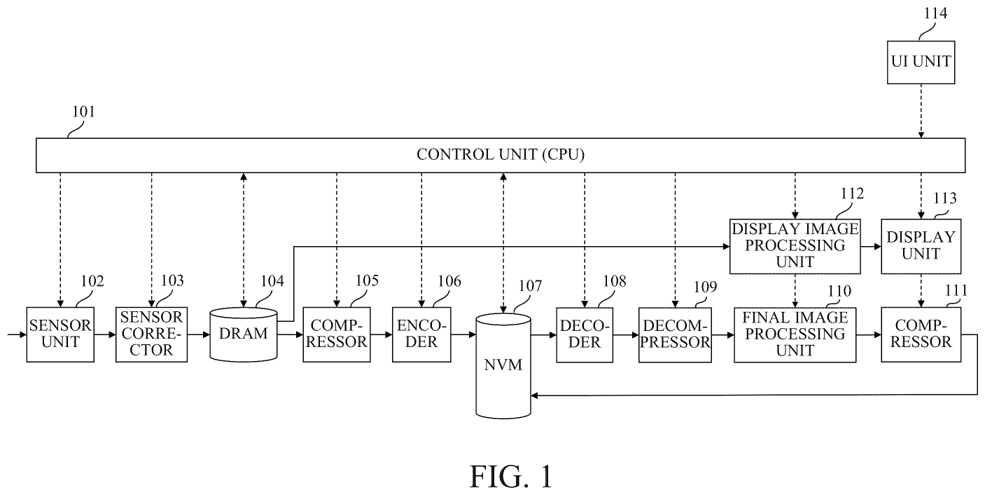

FIG. 1 illustrates the configuration of a digital still camera as an image pickup apparatus including an imaging control apparatus according to this embodiment. The imaging control apparatus according to this embodiment may be mounted not only on a digital still camera but also on various image pickup apparatuses such as a digital video camera, a smartphone, a cellular phone with a camera, and an on-board (in-vehicle) camera. The imaging control apparatus according to this embodiment may be provided as an external device, such as a personal computer, different from a camera (image sensor).

The image pickup apparatus includes a control unit 101, a sensor unit 102, a sensor corrector 103, a DRAM 104, a compressor 105, an encoder 106, a nonvolatile memory (NVM) 107, a decoder 108, a decompressor 109, a final (or definitive) image processing unit 110, a compressor 111, a display image processing unit 112, a display unit 113, a user interface (UI) unit 114, and an A/D converter configured to perform A/D conversion for an output of an unillustrated imaging lens and the sensor unit 102.

In the image pickup apparatus according to this embodiment, image data (first image data) for provisional recording is generated from an output of the sensor unit 102 by the sensor corrector 103, the DRAM 104, the compressor 105, and the encoder 106 and provisionally recorded in the nonvolatile memory 107. Then, image data (second image data) for final recording is generated based on the image data read out of the nonvolatile memory 107 by the decoder 108, the decompressor 109, the final image processing unit 110, and the compressor 111 and finally recorded in the nonvolatile memory 107.

The imaging control apparatus includes the control unit 101, the sensor corrector 103, the DRAM 104, the compressor 105, the encoder 106, the decoder 108, the decompressor 109, the final image processing unit 110, the compressor 111, and the display image processing unit 112. The control unit 101 corresponds to a controller. The sensor corrector 103, the compressor 105, and the encoder 106 constitute a first processing unit. Processing from imaging performed by the sensor unit 102 to provisional recording performed by the first processing unit corresponds to first processing (provisional recording processing). The decoder 108, the decompressor 109, the final image processing unit 110, and the compressor 111 constitute a second processing unit, and processing performed by the second processing unit from image data reading from the nonvolatile memory 107 to final recording corresponds to second processing (final recording processing). The first processing unit and the second processing unit constitute a processing unit.

The nonvolatile memory 107 may be attachable to and detachable from the image pickup apparatus (imaging control apparatus) or may be built into the imaging control apparatus.

The control unit 101 includes a microcomputer including a CPU and the like and provides various instructions to the sensor unit 102 to the display unit 113 described above as well as the imaging lens, an A/D converter, and the like and executes various kinds of processing in accordance with computer programs stored in the DRAM 104. The various kinds of processing include still image capturing processing and moving image capturing processing.

The sensor unit 102 includes an image sensor such as a CCD sensor or a CMOS sensor, which photoelectrically converts an object image (optical image) formed through the imaging lens. An output (imaging signal) of the sensor unit 102 is input to the sensor corrector 103.

The sensor corrector 103 generates raw image data from the output of the sensor unit 102 and further performs sensor correction such as pixel correction, black level correction, and shading correction for the raw image data (original image data). The raw image data for which the sensor correction is performed is written and temporarily stored in the DRAM 104 as a volatile memory.

The compressor 105 performs processing (referred to as provisional compression hereinafter) of compressing the image data sensor-corrected and read from the DRAM 104 before provisional recording is performed in the NVM 107. The provisional compression is intended to save a provisional recording area in the NVM 107 and reduce the necessary writing rate of image data for provisional recording (first image data; referred to as provisional recording data hereinafter). The provisional recording means temporary recording of the provisional recording data until image data for final recording (second image data; referred to as final recording data hereinafter) to be described later is recorded, and the NVM 107 in this case functions as a buffer.

The compressor 105 may not be provided in a case where saving of the provisional recording area and reduction of the necessary writing rate of the provisional recording data are unnecessary.

The sensor corrector 103 described above is provided before the NVM 107 to complete the sensor correction of the provisional recording data. However, the sensor corrector 103 may be provided between the decompressor 109 and the final image processing unit 110 in a case where completion of the sensor correction of the provisional recording data is not necessary.

The encoder 106 encodes the provisional recording data provisionally recorded in the NVM 107. The encoder 106 is provided to increase confidentiality of image data recorded in the NVM 107 but does not necessarily need to be provided.

The NVM 107 is a nonvolatile storage medium (nonvolatile memory) that stores the provisional recording data and the final recording data. The decoder 108 decodes the provisional recording data encoded by the encoder 106 and provisionally recorded in the NVM 107. The decoder 108 is unnecessary in a case where the encoder 106 is not provided as described above.

The decompressor 109 performs decompression processing for the provisional recording data provisionally compressed by the compressor 105 and decompresses the provisional recording data into the raw image data. The decompressor 109 is unnecessary in a case where the compressor 105 is not provided as described above.

The final image processing unit 110 generates final recording data by performing the final recording processing for the raw image data from the decompressor 109. The final recording processing includes various kinds of image processing other than the sensor correction performed by the sensor corrector 103, such as noise reduction, white balance adjustment, lateral chromatic aberration correction, demosaic processing, gamma correction, luminance and color generation processing, geometric deformation, and scaling up and down (enlargement and reduction). The demosaic processing may be performed on the provisional recording data before the provisional recording. However, as described later, a data amount of the provisional recording data increases through the demosaic processing as compared to before the demosaic processing, and thus the demosaic processing may be performed for the raw image data after the provisional recording.

The compressor 111 performs final compression processing such as JPEG compression (in a case of still image data) on the final recording data. The final recording data after the final compression processing is written (finally recorded) in the NVM 107.

FIG. 1 illustrates the provisional recording data and the final recording data stored in the same NVM 107, but the provisional recording data and the final recording data may be stored in separate NVMs. This will be described in detail later. The size of the provisional recording area in the same NVM 107, and NVMs in a case where the provisional recording data and the final recording data are stored in separate NVMs may be automatically managed by the control unit 101 or designated by a user as described later.

The display image processing unit 112 performs image processing for display (referred to as display image processing hereinafter) for the raw image data read out of the DRAM 104.

The display unit 113 displays display image data provided with the display image processing on an unillustrated display device such as an electronic viewfinder or a back surface panel. The user can check an imaging composition and the like while observing an image displayed on the display unit 113. In this embodiment, the raw image data is directly provided with the display image processing and displayed not through the NVM 107, and thus the display image processing and display can be performed without depending on access band restriction of the NVM 107.

The UI unit 114 is a user interface that enables various operations by the user such as a power on/off operation, a selection operation of an imaging mode, a setting operation of an imaging condition, an imaging operation, and an image playback operation. The UI unit 114 includes operation members such as a button switch, a directional pad, a dial, and a touch sensor provided at the display unit 113 for displaying menu images. The user can designate, through the UI unit 114, the size of the provisional recording area in the NVM 107, and NVMs for storing the provisional recording data and the final recording data.

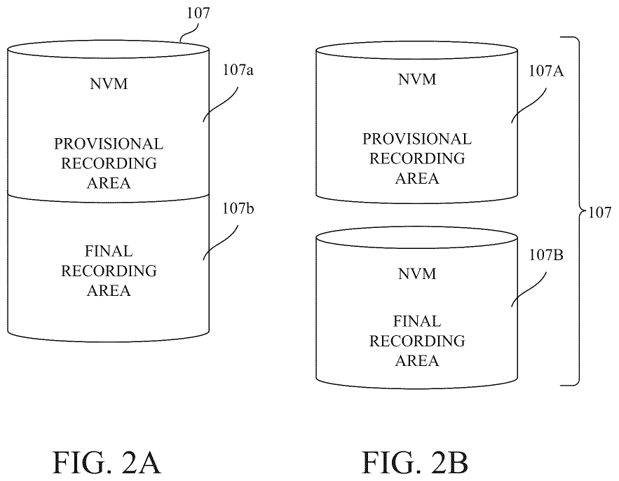

FIGS. 2A and 2B illustrate a configuration example of the NVM 107. FIG. 2A illustrates an example in which a single NVM 107 is divided by a physical or logical partition into a provisional recording area 107a for storing the provisional recording data and a final recording area 107b for storing the final recording data. As described above, the size of the provisional recording area is managed by the control unit 101 in accordance with the number of continuously shot still images (the number of still image continuous shots) and the continuous imaging duration of a moving image (moving image capturing duration) or is designated by the user.

The NVM 107 does not necessarily need to be clearly divided into the provisional recording area and the final recording area. In this case, the size of the provisional recording area is logically managed by the control unit 101, but the size of the provisional recording area and the number thereof may be dynamically changed in the NVM 107. However, by clearly dividing the provisional recording area and the final recording area as illustrated in FIG. 2A, the size of the provisional recording area can be fixedly secured as compared to a case without division. Thus, the number of continuously shot still images and the continuous imaging duration of a moving image can be secured in constant amounts, and troubles such as false deletion of the provisional recording data due to false operation by the user can be more easily avoided.

In FIG. 2B, an NVM 107A for provisional recording area and an NVM 107B for final recording area are separately provided. In this embodiment, these two NVMs 107A and 107B can be simultaneously accessed in parallel as compared to a case where the provisional recording area and the final recording area are provided in the single NVM 107. Thus, it is possible to secure high writing and reading rates of the provisional recording data for the access band upper limit of the NVM 107A. The provisional recording area in the NVM 107A may be divided into a plurality of areas and their sizes may be managed by the control unit 101.

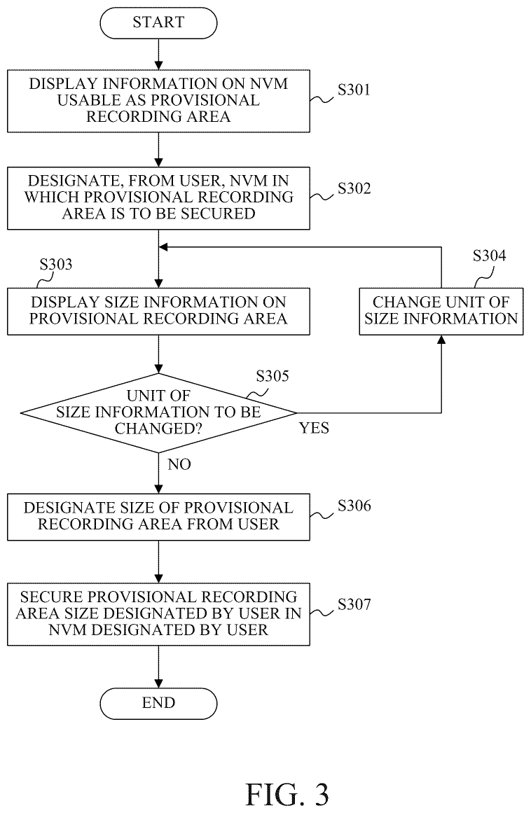

FIG. 3 illustrates a flowchart of processing in which the user selects an NVM in which the provisional recording area is to be provided and designates the size of the provisional recording area. In the flowchart, “S” means “step”. The control unit 101 starts the present processing when a menu regarding the provisional recording area is selected by a user operation.

First at S301, the control unit 101 displays, on the display unit 113, information on any NVM 107 in which the provisional recording area can be provided. The displayed information is, for example, information that specifies the NVM 107, such as whether the NVM 107 is a built-in memory or a memory inserted into a media slot, and a slot into which the memory is inserted in a case where there are a plurality of media slots, and information such as the storage capacity of the NVM 107.

Next at S302, the control unit 101 causes the user to designate the NVM 107 in which the provisional recording area is to be disposed.

Next at S303, the control unit 101 displays, on the display unit 113, information on the size of the provisional recording area in the NVM 107, for example, size information in a case where the provisional recording area is secured at maximum. The unit of the size information can be selected from among the number of bytes, the number of recordable still images, the continuous imaging duration, and the like.

Next at S305, the control unit 101 determines whether the user has performed an operation to change (select) the unit of the size information, and proceeds to S304 in a case where the change operation has been performed or S306 in a case where the change operation has not been performed.

At S304, the control unit 101 changes the unit of the size information to the unit selected by the user and displays information on the size of the provisional recording area on the display unit 113 again at S303.

At S306, the control unit 101 causes the user to designate the size of the provisional recording area. The size information indicating the designated size is displayed on the display unit 113 in the unit that is set at that time.

Next at S307, the control unit 101 secures the provisional recording area in the size designated by the user in the NVM 107 designated by the user. Then, this flow ends.

Next follows a description of an average writing rate WR of the provisional recording data to the NVM 107, an imaging rate SR of the sensor unit 102, a provisional recording data size IS that is the data size of the provisional recording data (image data), and a provisional compression ratio CR that is the compression ratio of the compressor 105. The provisional recording data size IS is the size of the image data before the provisional compression by the compressor 105. The imaging rate SR is the average imaging rate during still image continuous shooting or the frame rate of moving image capturing. In the following description, still image continuous shooting and moving image capturing are also collectively referred to as continuous imaging.

A relationship among the average writing rate (simply referred to as writing rate hereinafter) WR [Byte/see], the imaging rate SR [FPS], the provisional recording data size IS [Byte], and the provisional compression ratio CR (such as ½, ¼, ⅕, or 0.23) is expressed by inequality (1) below:

$$WR \geq IS \times CR \times SR \qquad ( 1 )$$

The control unit 101 controls the first processing from imaging to provisional recording to obtain the writing rate WR equal to or higher than a speed determined based on the writing rate WR, in other words, the imaging rate SR, the provisional recording data size IS, and the provisional compression ratio CR with which inequality (1) holds. In a case where inequality (1) holds, the provisional recording data can be continuously written until the provisional recording area in the NVM 107 becomes full even when the continuous imaging is performed at the imaging rate SR. In this case, processing performance higher than the imaging rate SR is needed for the sensor corrector 103, the compressor 105, and the encoder 106.

On the other hand, processing performance higher than the imaging rate SR is not needed for reading of the provisional recording data from the NVM 107 and the final recording processing such as final image processing and final compression, which are processing after the provisional recording data is written. Thus, processing can be performed at a predetermined (arbitrary) rate or timing that does not depend on the imaging rate SR.

Inequality (2) below is obtained from inequality (1):

$$CR \leq \frac{WR}{IS \times SR} \qquad ( 2 )$$

That is, the provisional compression ratio CR with which the continuous imaging can be performed until the provisional recording area becomes full can be set based on the imaging rate SR, the provisional recording data size IS, and the writing rate WR. For example, it is possible to perform control such as setting of the provisional compression ratio CR based on the speed of continuous shooting (the imaging rate SR), or setting of the provisional compression ratio CR after checking the writing rate WR of a removable NVM 107.

Inequality (3) below is obtained from inequality (1):

$$SR \leq \frac{WR}{IS \times CR} \qquad ( 3 )$$

That is, the imaging rate SR with which the continuous imaging can be performed until the provisional recording area becomes full can be set based on the provisional recording data size IS, the provisional compression ratio CR, and the writing rate WR. For example, it is possible to perform control such as such as setting of the maximum speed of continuous shooting (maximum imaging rate SR) based on the provisional compression ratio CR with which certain image quality can be guaranteed, and setting of the maximum speed of continuous shooting after checking the writing rate WR of a removable NVM 107.

On the other hand, the following inequalities (4) to (7) express a relationship among a continuous shooting number BN, a continuous imaging duration BT [sec], a buffer size BS [Byte] of the DRAM 104, the writing rate WR, the imaging rate SR, the provisional recording data size IS, and the provisional compression ratio CR under a condition that the continuous imaging cannot be performed until the provisional recording area becomes full:

$$WR < IS \times CR \times SR \qquad ( 4 )$$

$$BT < \frac{BS}{IS \times CR \times SR - WR} \qquad ( 5 )$$

$$BN < \frac{BS \times SR}{IS \times CR \times SR - WR} \qquad ( 6 )$$

$$BN = BT \times SR \qquad ( 7 )$$

In a case where inequality (4) holds, the provisional recording data cannot be continuously written until the provisional recording area becomes full even when the continuous imaging is performed at the imaging rate SR. In this case, the maximum continuous imaging duration BT can be calculated from the buffer size BS, the provisional recording data size IS, the provisional compression ratio CR, the imaging rate SR, and the writing rate WR as indicated by inequality (5).

From the relationship between the continuous shooting number BN and the continuous imaging duration BT, which is expressed by inequality (7), the continuous shooting number BN is expressed by inequality (6) from inequality (5) and can be calculated from the buffer size BS, the provisional recording data size IS, the provisional compression ratio CR, the imaging rate SR, and the writing rate WR. In this case, processing performance higher than the imaging rate SR is needed for the sensor corrector 103, the compressor 105, and the encoder 106.

On the other hand, processing performance higher than the imaging rate SR is not needed for reading of the provisional recording data from the NVM 107 and the final recording processing such as final image processing and final compression, which are processing after writing of the provisional recording data. Thus, processing can be performed at a predetermined (arbitrary) rate or timing that does not depend on the imaging rate SR.

Inequalities (8) and (9) below are obtained from inequalities (5) and (6):

$$CR < \frac{BS + BT \times WR}{BT \times IS \times SR} \qquad ( 8 )$$

$$CR < \frac{BS \times SR + BN \times WR}{BN \times IS \times SR} \qquad ( 9 )$$

That is, the provisional compression ratio CR with which the continuous imaging can be performed until the continuous imaging duration reaches BT can be set based on the buffer size BS, the imaging rate SR, the provisional recording data size IS, and the writing rate WR. For example, it is possible to perform control such as setting of the provisional compression ratio CR based on the speed of continuous shooting (the imaging rate SR), setting of the provisional compression ratio CR after checking the writing rate WR of a removable NVM 107, and setting of the provisional compression ratio CR based on the continuous imaging duration BT designated by the user.

Moreover, the provisional compression ratio CR with which still images can be continuously shot until the number of continuous shots reaches BN can be set based on the buffer size BS, the imaging rate SR, the provisional recording data size IS, and the writing rate WR. For example, it is possible to perform control such as setting of the provisional compression ratio CR based on the speed of continuous shooting (the imaging rate SR), setting of the provisional compression ratio CR after checking the writing rate WR of a removable NVM 107, and setting of the provisional compression ratio CR based on the continuous shooting number BN designated by the user.

Inequalities (10) and (11) below are obtained from inequalities (5) and (6):

$$SR < \frac{BS + BT \times WR}{BT \times IS \times CR} \qquad ( 10 )$$

$$SR < \frac{BS \times SR + BN \times WR}{BN \times IS \times CR} \qquad ( 11 )$$

That is, the maximum speed of continuous shooting (the imaging rate SR) with which continuous shooting can be performed until the continuous imaging duration reaches BT can be set based on the buffer size BS, the provisional recording data size IS, the provisional compression ratio CR, and the writing rate WR. For example, it is possible to perform control such as setting of the maximum speed of continuous shooting (the imaging rate SR) based on the provisional compression ratio CR with which certain image quality can be guaranteed, setting of the maximum speed of continuous shooting after checking the writing rate WR of a removable NVM 107, and setting of the maximum speed of continuous shooting based on the continuous imaging duration BT designated by the user.

Moreover, the maximum speed of continuous shooting (the imaging rate SR) with which continuous shooting can be performed until the number of continuous shots reaches BN can be set based on the buffer size BS, the provisional recording data size IS, the provisional compression ratio CR, and the writing rate WR. For example, it is possible to perform control such as setting of the maximum speed of continuous shooting based on the provisional compression ratio CR with which certain image quality can be guaranteed, setting of the maximum speed of continuous shooting after checking the writing rate WR of a removable NVM 107, and setting of the maximum speed of continuous shooting based on the continuous shooting number BN designated by the user.

Next follows a description of a case where an access rate AR [Byte/see] of the NVM 107 has allowance for the provisional recording data size IS, the provisional compression ratio CR, and the imaging rate SR as expressed by inequality (12) below:

$$AR > IS \times CR \times SR \qquad ( 12 )$$

In this case, since the access rate AR of the NVM 107 has allowance even during the continuous imaging, final image processing, final compression, and final recording can be performed simultaneously with the continuous imaging at a processing rate in accordance with a reading rate RR [Byte/see] of the provisional recording data.

In a case where the NVM 107A used for the provisional recording data and the NVM 107B used for the final recording data are different as illustrated in FIG. 2B, the reading rate RR of the provisional recording data can be expressed by inequality (13) below from inequality (12):

$$RR \leq AR - IS \times CR \times SR \qquad ( 13 )$$

At this time, the maximum reading rate RR of the provisional recording data can be set based on the maximum access rate AR of the provisional recording data, the provisional recording data size IS, the provisional compression ratio CR, and the imaging rate SR. For example, it is possible to perform control such as setting the processing rates of the final image processing and the final compression based on the provisional compression ratio CR with which certain image quality can be guaranteed, and setting of the processing rates of the final image processing and the final compression after the access rate AR of the removable NVM 107A is checked.

In this embodiment, the final image processing unit 110 and the compressor 111 have processing performance higher than the reading rate RR, and writing performance of the final recording data to the NVM 107B is high enough not to limit the reading rate RR.

In a case where the same NVM 107 is used for the provisional recording data and the final recording data as illustrated in FIG. 2A, the reading rate RR of the provisional recording data can be expressed by inequality (14) below from inequality (12). FIS [Byte] is the size (hereinafter referred to as a final recording data size) of image data as the final recording data, and FCR is the compression ratio (hereinafter referred to as a final compression ratio) of the final compression by the compressor 111. The final recording data size FIS is the size of final recording image data before the final compression by the compressor 111. The final compression ratio FCR is, for example, ⅛, 1/10, 1/16, or 0.07.

$$RR \leq \frac{( AR - IS \times CR \times SR ) \times IS \times CR}{IS \times CR + FIS \times FCR} \qquad ( 14 )$$

In this case, the maximum reading rate RR of the provisional recording data can be set based on the maximum access rate AR of the provisional recording data, the provisional recording data size IS, the provisional compression ratio CR, the imaging rate SR, the final recording data size, and the final compression ratio FCR.

The final image processing unit 110 and the compressor 111 have processing performance higher than the reading rate RR. In this case, for example, it is possible to perform control such as setting of the processing rates of the final image processing and the final compression based on the provisional compression ratio CR with which certain image quality can be guaranteed, and setting of the processing rates of the final image processing and the final compression after checking the access rate AR of a removable NVM 107.

The above configuration can eliminate dependency of the writing and reading rates of the provisional recording data to and from the NVM 107 on the imaging rate, the number of continuous shots, or the continuous imaging duration. As a result, necessity is reduced to increase the processing rates of the final image processing and the final compression after the provisional recording data is read from the NVM 107, and it is possible to suppress performance increase (scale-up) of a circuit including the final image processing unit 110 and the compressor 111 and power consumption increase along with the performance increase.

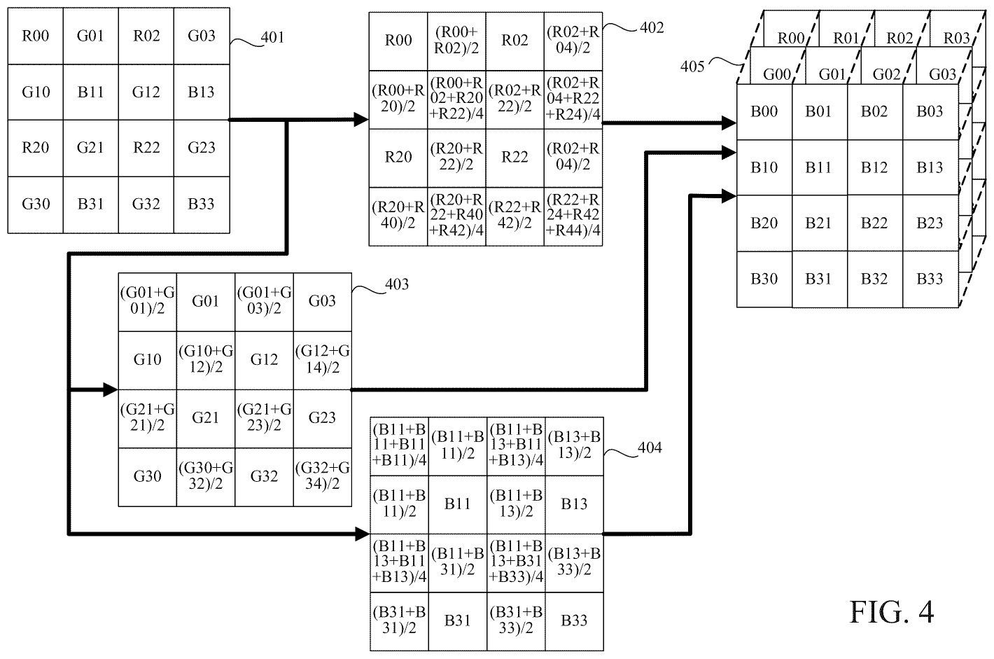

FIG. 4 illustrates an example of the demosaic processing. Reference number 401 denotes image data (hereinafter referred to as a Bayer image) of a Bayer array. Pixels of red (R) and green (G) are repeatedly disposed in odd-numbered rows such as the first and third rows. Pixels of G and blue (B) are repeatedly disposed in even-numbered rows such as the second and fourth rows.

Reference number 402 denotes interpolation processing with R pixel values. R pixels are disposed every other pixel in odd-numbered rows of the Bayer image, and the values of these R pixel are output as they are. The value of an R pixel at the position of a G pixel in the Bayer image is calculated from the average of the pixel values of two R pixels on the right and left sides or upper and lower sides of the G pixel. The value of an R pixel at the position of a B pixel in the Bayer image is calculated from the average of the pixel values of four R pixels on the upper-left, upper-right, lower-left, and lower-right sides of the B pixel.

Reference number 403 denotes interpolation processing with G pixel values. The pixel values of G pixels in the Bayer image are output as they are. The value of a G pixel at the position of an R or B pixel in the Bayer image is calculated from the average of the pixel values of G pixels on the right and left sides of the R or B pixel.

Reference number 404 denotes interpolation processing with B pixel values. B pixels are disposed every other pixel in even-numbered rows of the Bayer image, and the values of these B pixels are output as they are. The value of a B pixel at the position of a G pixel in the Bayer image is calculated from the average of the pixel values of two B pixels on the right and left sides or upper and lower sides of the G pixel. The value a B pixel at the position of an R pixel in the Bayer image is calculated from the average of the pixel values of four B pixels on the upper-left, upper-right, lower-left, and lower-right sides of the R pixel.

Reference number 405 denotes output image data made of R image data, G image data, and B image data after the above interpolation processing (402, 403, and 404).

Thus, the data size of the output image data 405 after the demosaic processing is three times as large as that of the Bayer image 401 before the demosaic processing.

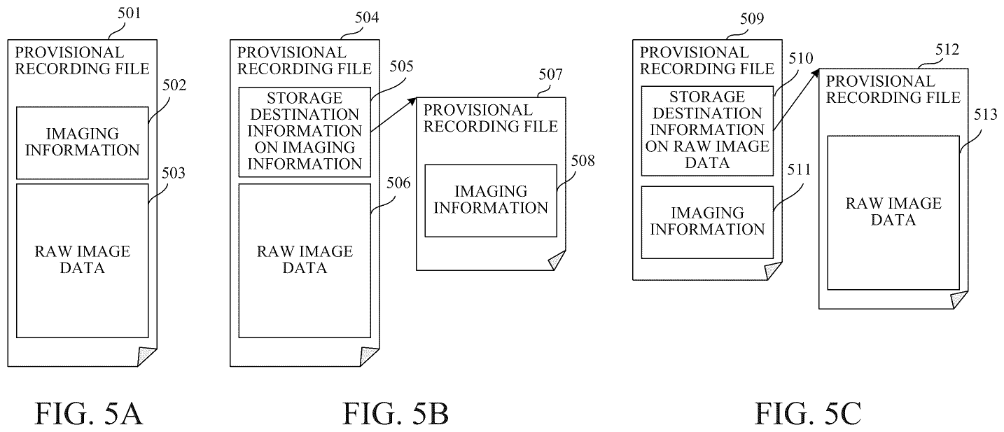

Referring now to FIGS. 5A, 5B, and 5C, a description will be given of the storage format of the provisional recording data in the NVM 107. Next follows a description of a case where the provisional recording data is stored in a file format in the NVM 107 as an example.

FIG. 5A illustrates imaging information 502 and raw image data 503 stored in a single provisional recording file 501. The imaging information 502 includes various kinds of information on imaging for acquiring the raw image data 503, for example, an imaging mode and imaging parameters. The imaging information 502 is attached to the raw image data 503, as information for setting parameters in the final image processing and the final compression. The raw image data 503 is sensor-corrected, compressed, and coded, captured image data before the final recording processing.

In this manner, the imaging information 502 is recorded in the NVM 107 in association with the raw image data 503. Thereby, even when a situation occurs that the final image processing or the final compression is interrupted by power shutdown or the like and data being processed is lost, the processing can be completed by resuming the final image processing, the final compression, and the final recording using the raw image data 503 and the imaging information 502. Thus, the loss risk of image data can be minimized even when battery shortage or power shutdown unintended by the user has occurred.

In FIG. 5B, a provisional recording file (first area) 504 storing storage destination information 505 of imaging information and raw image data 506, and a provisional recording file (second area) 507 storing imaging information 508 are separately provided. The storage destination information 505 includes file information (information indicating the second area) such as path information on the provisional recording file 507 and the file name of the provisional recording file 507. The raw image data 506 is the same as the raw image data 503 illustrated in FIG. 5A. The imaging information 508 is the same as the imaging information 502 illustrated in FIG. 5A.

In this case as well, the imaging information 508 is recorded in the NVM 107 in association with the raw image data 506. Thereby, even when a situation occurs that the final image processing or the final compression is interrupted by power shutdown or the like and data being processed is lost, the processing can be completed by resuming the final image processing, the final compression, and the final recording using the raw image data 506 and the imaging information 508. Thus, the loss risk of image data can be minimized even when battery shortage or power shutdown unintended by the user has occurred.

In FIG. 5C, a provisional recording file (first area) 509 storing storage destination information 510 of raw image data and imaging information 511, and a provisional recording file (second area) 512 storing raw image data 513 are separately provided. The storage destination information 510 includes file information (information indicating the second area) such as path information on the provisional recording file 512 and the file name of the provisional recording file 512. The imaging information 511 is the same as the imaging information 502 illustrated in FIG. 5A. The raw image data 513 is the same as the raw image data 503 illustrated in FIG. 5A.

In this case as well, the imaging information 511 is recorded in the NVM 107 in association with the raw image data 513. Thereby, even when a situation occurs that the final image processing or the final compression is interrupted by power shutdown or the like and data being processed is lost, the processing can be completed by resuming the final image processing, the final compression, and the final recording using the raw image data 513 and the imaging information 511. Thus, the loss risk of image data can be minimized even when battery shortage or power shutdown unintended by the user has occurred.

In this embodiment, imaging information is managed and stored in association with raw image data, imaging information on a plurality of raw image data may be collectively managed in a dedicated management file in the NVM 107.

In this embodiment, raw image data as the provisional recording data is sensor-corrected, compressed, and coded, captured image data before the final image processing, but is not limited to this example. For example, image processing completed before raw image data associated with imaging information is provisionally recorded as the provisional recording data may be clearly distinguished from uncompleted image processing to be performed thereafter. In other words, uncompleted image processing may be resumable even when a situation occurs that the final image processing or the final compression is interrupted by power shutdown or the like and data being processed is lost. However, in a case where captured image data is image data in the Bayer array, performing the demosaic processing in the final image processing can reduce the data size of the provisional recording data, and the usage of the provisional recording area.

In this embodiment, the provisional recording data in the NVM 107 is stored in a file format, but the storage is not limited to the file format and the provisional recording data may be stored in any other storage format or management format in the NVM 107.

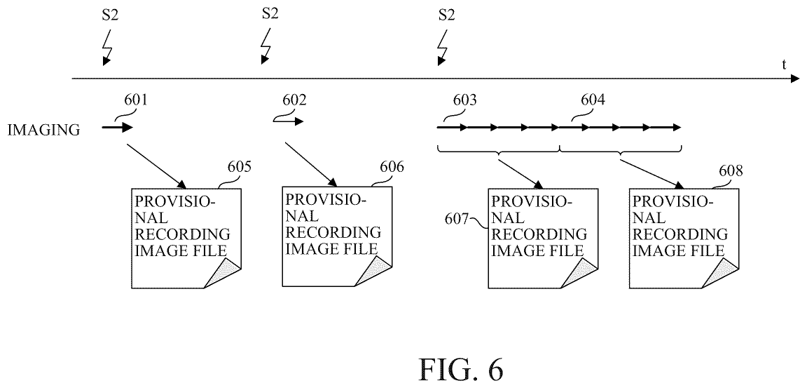

In FIG. 6, captured image data (provisional recording data) as a plurality of raw image data obtained by still image continuous shooting is collectively stored in a single provisional recording file, rather than in separate provisional recording files, and recorded in the NVM 107. In FIG. 6, elapse of time t is illustrated from the left to the right. S2 denotes a timing at which still image capturing is performed. Single imaging (single shooting) 601 and 602 is performed at the first two S2s, and continuous shooting 603 is performed at the third S2.

One raw image datum is stored in a provisional recording file 605 at the single shooting 601, one raw image datum is stored in another provisional recording file 606 at the single shooting 602, and these files are recorded in the NVM 107.

When the continuous shooting 603 is started, four raw image data are collectively stored in a provisional recording file 607, four raw image data from an ongoing state 604 of continuous shooting are collectively stored in another provisional recording file 608, and these files are recorded in the NVM 107. Thus, a predetermined number of raw image data may be stored in a single provisional recording file or a plurality of raw image data generated in a predetermined continuous duration may be stored in a single provisional recording file.

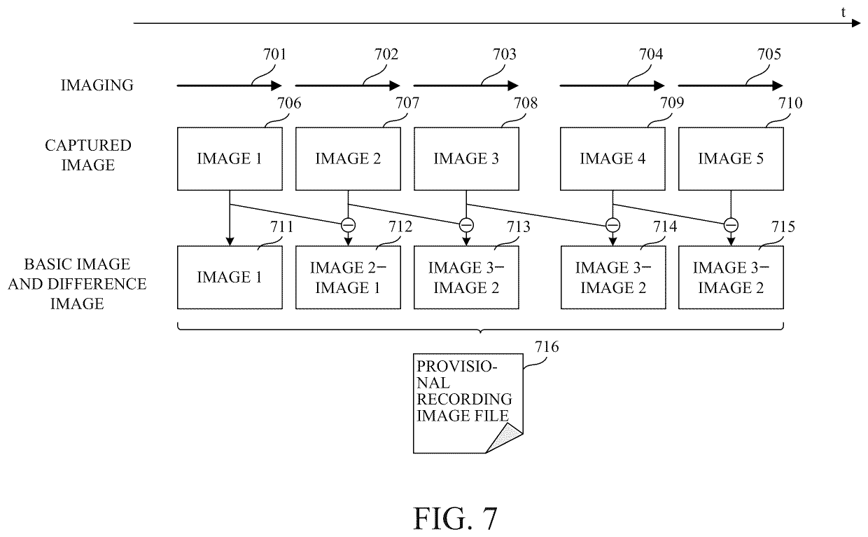

FIG. 7 illustrates an example method of reducing recording target data by utilizing the correlation between captured image data in the continuous shooting 603 (604) in FIG. 6. Reference numbers 701 to 705 each denote single still image capturing in continuous shooting. Images 1 to 5 as captured image data are acquired by the still image capturing 701 to 705, respectively.

Head image 1 (711) as basic image data acquired by the first imaging is selected as the recording target data, and difference data 712 to 715 between an image (n+1) and an image n (n=1 to 5) is generated. The difference data may be that between pre-sensor-correction captured image data, or may be that between post-sensor-correction captured image data. Thus, since the recording target data is set to the difference data of captured image data, the data size of the provisional recording data can be smaller by efficiently compressing the recording target data with reduced redundancy than that where the recording target data is set to all captured image data.

In this embodiment, the recording target data is reduced by utilizing the correlation between images acquired by continuous (adjacent or sequential) still image capturing, but the correlation between images other than images acquired by adjacent imaging, such as the correlation between the head image and another image, may be utilized. Moreover, the compression efficiency may be improved not only by utilizing a difference between images but also by detecting object movement in a common area of images and extracting the moving amount.

In this embodiment, still image continuous shooting is used as an example, but the provisional recording can be similarly performed during moving image capturing.

In FIG. 7, a time interval between imaging 704 and imaging 705 is different from that between another imaging pair. Even in a case where the inter-imaging time interval changes in this manner, compression utilizing a correlation between images and collective storage in a single provisional recording file may be performed as long as a change width (amount) is within a predetermined time.

Thus, collectively storing a plurality of captured image data in a single provisional recording file based on a predetermined criterion can perform efficient processing with reduced overhead of file production and increased freedoms in the final image processing, the final compression, and the final recording.

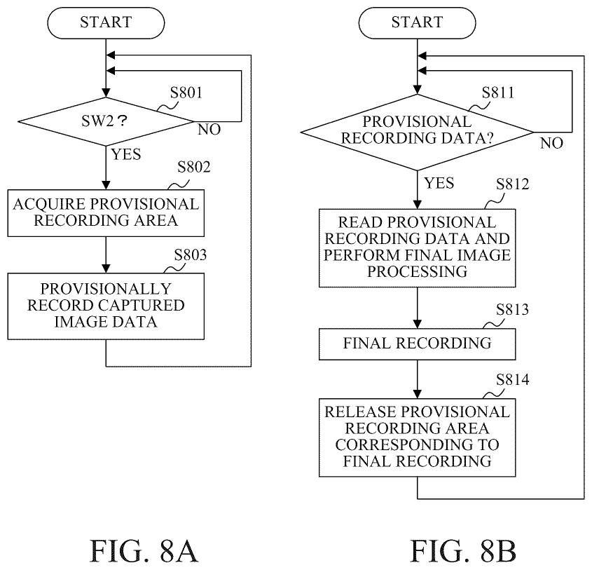

FIGS. 8A and 8B are flowcharts illustrating acquisition and release processing of the provisional recording area executed by the control unit 101. The flowchart of FIG. 8A illustrates imaging processing.

At S801, the control unit 101 determines whether the user has performed an imaging operation (SW2 operation) through the UI unit 114, and repeats the determination until the SW2 operation is performed, or starts imaging (still image continuous shooting or moving image capturing) in a case where the SW2 operation has been performed. Then, the flow proceeds to S802.

At S802, the control unit 101 acquires the provisional recording area in the NVM 107.

At S803, the control unit 101 provisionally records captured image data (provisional recording data) in the provisional recording area acquired at S802. Then, the flow returns to S801.

The flowchart of FIG. 8B illustrates processing of performing final recording and releasing the provisional recording area after the provisional recording data is provisionally recorded.

At S811, the control unit 101 determines whether the provisional recording data exists in the NVM 107. The flow returns to S811 in a case where no provisional recording data exists, or the flow proceeds to S812 in a case where the provisional recording data exists.

At S812, the control unit 101 reads the provisional recording data from the NVM 107, causes the final image processing unit 110 to perform the final image processing for the provisional recording data and generate the final recording data, and causes the compressor 111 to perform the final compression of the final recording data.

Next at S813, the control unit 101 finally records, in the final recording area in the NVM 107, final recording image data finally compressed.

Next at S814, the control unit 101 deletes, from the NVM 107, the provisional recording data corresponding to the final recording data finally recorded (from which the final recording data is produced), and releases the provisional recording area in the NVM 107. Then, the flow returns to step S811.

Through the above imaging processing, it is guaranteed that captured image data is provisionally or finally recorded in the NVM 107. Thereby, it is possible to reduce the loss risk of captured image data when battery shortage or power shutdown unintended by the user has occurred.

Some NVMs 107 have a restricted number of writings due to physical properties. In such an NVM 107, in a case where the writing frequency becomes high in some biased recording areas, only these recording areas become unable to be used. To avoid this problem, control may be performed so that the writing frequency becomes equal as much as possible among recording areas (in particular, so as to average (or equalize) the recording frequency of the provisional recording data among a plurality of provisional recording areas).

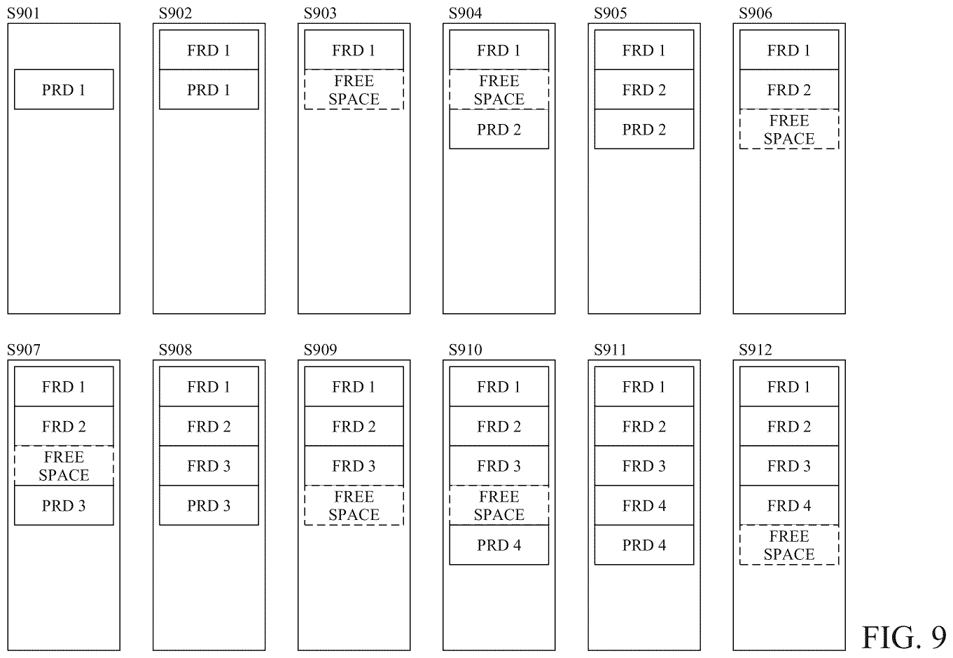

FIG. 9 illustrates processing of setting the provisional recording area and the final recording area in the NVM 107. Steps of S901 to S912 sequentially set recording areas of the provisional recording data and the final recording data in the NVM 107.

At S901, the control unit 101 records provisional recording data (PRD) 1 acquired first in a first provisional recording area. In this process, a recording area is left available in the first provisional recording area so as to record the final recording data.

At S902, the control unit 101 records, in a recording area that is free at S901, final recording data (FRD) 1 generated by performing the final image processing and the final compression for the provisional recording data 1.

At S903, the control unit 101 deletes the provisional recording data 1 and sets as free space the recording area where that data has been recorded.

At S904, the control unit 101 maintains the free space at S903 and records provisional recording data 2 next acquired in a second provisional recording area below the free space.

At S905, the control unit 101 records, in the free space maintained at S904, final recording data 2 generated by performing the final image processing and the final compression for the provisional recording data 2. In other words, the newly generated free space is preferentially used as a recording area for the final recording data.

At S906, the control unit 101 deletes the provisional recording data 2 and sets as free space, the recording area where that data has been recorded.

At S907, the control unit 101 maintains the free space at S906 and records provisional recording data 3 next acquired in a third provisional recording area below the free space.

At S908, the control unit 101 records, in the free space maintained at S907, final recording data 3 generated by performing the final image processing and the final compression for the provisional recording data 3.

At S909, the control unit 101 deletes the provisional recording data 3 and sets as free space, the recording area where that data has been recorded.

At S910, the control unit 101 maintains the free space at S909 and records provisional recording data 4 next acquired in a fourth provisional recording area below the free space.

At S911, the control unit 101 records, in the free space maintained at S910, final recording data 4 generated by performing the final image processing and the final compression for the provisional recording data 4.

At S912, the control unit 101 deletes the provisional recording data 4 and sets as free space, the recording area where that data has been recorded.

Using recording areas as described above can avoid bias in the writing frequency in some recording areas of the NVM 107 and equalize the writing frequency among the recording areas.

In FIG. 9, the provisional recording data and the final recording data have the same data size, but in a case where they have different data sizes, recording areas may be set in accordance with the larger data size. Moreover, the above processing may be performed for logical recording areas and the association may be separately managed between the settings of physical recording areas and the settings of logical recording areas. Thus, the physical recording areas may not cooperate with the setting of recording areas unlike FIG. 9.

In FIG. 9, the imaging rate, the final image processing rate, and the final compression rate are executed at the same processing rate, but the recording areas can be similarly set even if the imaging rate is higher, and imaging and writing of the provisional recording data continuously precede.

Unlike the example illustrated in FIG. 9, another method may be used in which, for example, the number of writings (the number of recordings) in a plurality of recording areas is managed and a recording area with fewer writings than the other recording areas is preferentially allocated as the provisional recording area.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

This embodiment can improve the number of continuous shots and the continuous imaging duration without enhancing circuit performance.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims priority to Japanese Patent Application No. 2023-156605, which was filed on Sep. 22, 2023, and which is hereby incorporated by reference herein in its entirety.

What is claimed is:

1. An imaging control apparatus comprising:
a processor configured to:
generate first image data for provisional recording in a nonvolatile memory from an output of an image sensor configured to perform imaging,
control first processing from the imaging to the provisional recording,
generate second image data for final recording by performing second processing for the first image data read out of the nonvolatile memory, and
control the first processing so that an average writing rate of the first image data in the provisional recording can be equal to or higher than a speed based on an imaging rate of the image sensor.

2. The imaging control apparatus according to claim 1, wherein the speed based on the imaging rate is a speed obtained from the imaging rate, a size of the first image data, and a compression ratio for compressing the first image data.

3. An imaging control apparatus comprising:
a processor configured to:
generate first image data for provisional recording in a nonvolatile memory from an output of an image sensor configured to perform imaging,
control first processing from the imaging to the provisional recording,
generate second image data for final recording by performing second processing for the first image data read out of the nonvolatile memory, and
control an imaging rate of the image sensor based on an average writing rate of the first image data in the provisional recording.

4. The imaging control apparatus according to claim 1, wherein the second processing includes demosaic processing.

5. The imaging control apparatus according to claim 1, wherein the processor is configured to provide a provisional recording area and a final recording area to the nonvolatile memory and sets a size of the provisional recording area based on designation by a user.

6. The imaging control apparatus according to claim 5, wherein the designation by the user is performed by the number of still image continuous shots or a moving image capturing duration.

7. The imaging control apparatus according to claim 1, wherein the processor is configured to perform the provisional recording by attaching information on the imaging in generating the first image data to the first image data.

8. The imaging control apparatus according to claim 1, wherein the processor is configured to provide a first area and a second area for the provisional recording to the nonvolatile memory,
wherein one of the first image data and information on the imaging in generating the first image data is recorded in the first area and the other is recorded in the second area, and
wherein information indicating the second area is recorded in the first area.

9. The imaging control apparatus according to claim 1, wherein the first processing includes at least one of sensor correction, compression, and encoding.

10. The imaging control apparatus according to claim 1, wherein the first processing includes at least two of sensor correction, compression, and encoding, and
wherein the sensor correction is executed before other processing included in the first processing in a case where the sensor correction is included in the first processing, and the encoding is executed after other processing included in the first processing in a case where the encoding is included in the first processing.

11. The imaging control apparatus according to claim 1, wherein the second processing includes decompression of the first image data after the first image data that has been provisionally recorded in the nonvolatile memory through compression is read, final image processing of decompressed first image data, and the final recording in the nonvolatile memory of the second image data that has been generated by the final image processing, and
wherein the processor is configured to set a reading rate of the first image data from the nonvolatile memory, a processing rate of the final image processing, and an average writing rate of the second image data in the nonvolatile memory based on a size of the first image data, the average writing rate in the provisional recording, the imaging rate, and a compression ratio of the compression.

12. The imaging control apparatus according to claim 1, wherein the second processing includes decompression of the first image data after the first image data that has been provisionally recorded in the nonvolatile memory through compression is read, final image processing of decompressed first image data, and the final recording of the second image data that has been generated by the final image processing, in another nonvolatile memory different from the nonvolatile memory, and
wherein the processor is configured to set a reading rate of the first image data from the nonvolatile memory and a processing rate of the final image processing based on a size of the first image data, the average writing rate in the provisional recording, the imaging rate, and a compression ratio of the compression.

13. The imaging control apparatus according to claim 1, wherein in the first processing, the provisional recording is performed by storing, in a single provisional recording file, a predetermined number of first image data generated by still image continuous shooting or the first image data generated in a predetermined continuous duration in still image continuous shooting.

14. The imaging control apparatus according to claim 1, wherein the first image data that has been provisionally recorded is deleted from the nonvolatile memory after the final recording of the second image data corresponding to the first image data is performed.

15. The imaging control apparatus according to claim 1, wherein the first processing averages recording frequency of the first image data in a plurality of provisional recording areas in the nonvolatile memory.

16. The imaging control apparatus according to claim 15, wherein the first processing preferentially uses an area with fewer recordings among the plurality of provisional recording areas as a provisional recording area for the first image data.

17. The imaging control apparatus according to claim 14, wherein an area in which the first image data corresponding to the second image data that has been finally recorded has been recorded is set as free space by deleting the first image data, and the free space is preferentially used as another final recording area for the second image data.

18. An image pickup apparatus comprising:
the imaging control apparatus according to claim 1; and
the image sensor.

19. An imaging control method comprising the steps of:
generating first image data for provisional recording in a nonvolatile memory from an output of an image sensor configured to perform imaging,
generating second image data for final recording by performing second processing for the first image data read out of the nonvolatile memory, and
controlling first processing so that an average writing rate of the first image data in the provisional recording can be equal to or higher than a speed based on an imaging rate of the image sensor.

20. An imaging control method comprising the steps of:
generating first image data for provisional recording in a nonvolatile memory from an output of an image sensor configured to perform imaging,
generating second image data for final recording by performing second processing for the first image data read out of the nonvolatile memory, and
controlling an imaging rate of the image sensor based on an average writing rate of the first image data in the provisional recording.
